(19) United States
(12) Patent Application Publication
(10) Pub. No.: US 2017/0295039 A1
(43) Pub. Date: Oct. 12, 2017

(54) DECISION FEEDBACK EQUALIZER

(71) Applicant: FUJITSU LIMITED, Kawasaki-shi (JP)

(72) Inventor: Yasuo HIDAKA, Cupertino, CA (US)

(73) Assignee: FUJITSU LIMITED, Kawasaki-shi (JP)

(21) Appl. No.: 15/096,172

(22) Filed: Apr. 11, 2016

(51) Int. Cl. H04L 25/03

(52) U.S. Cl. CPC H04L 25/03057

(57) ABSTRACT

A decision feedback equalizer may include an input node, first and second paths, and a summation circuit. The input node may be configured to receive an input signal with an input symbol rate. The first and second paths may receive the input signal. The first path may include a first register configured to output a first signal based on the input signal such that the first signal has a sample symbol rate less than the input symbol rate. The second path may include a second register configured to output a second signal at the sample symbol rate based on the input signal. The summation circuit may be positioned between the input node and the first and second paths. The summation circuit may subtract the first and seconds signals at the sample symbol rate from the input signal before the input signal is provided to the first and second paths.

### FIELD

The embodiments discussed in the present disclosure are related to decision feedback equalizers.

### BACKGROUND

Digital communication receivers typically sample a received analog waveform and detect sampled data of a serial link. As clock rates of the serial links increase to meet demand for higher data throughput, transmitted signals arriving at a receiver are increasingly susceptible to corruption by frequency-dependent signal loss of the channel, such as inter-symbol interference (ISI), and other noise, such as crosstalk, echo, signal dispersion and distortion.

Receivers may be configured to provide equalization of the channel to compensate for such signal degradation to correctly decode the received signals. For example, a decision-feedback equalizer (DFE) may be used to remove ISI and other noise to determine a correct data sequence from the received signal.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a decision feedback equalizer may include an input node, a first path, a second path, and a summation circuit. The input node may be configured to receive an input signal with an input symbol rate.

The first path may be configured to receive the input signal. The first path may include a first register configured to output a first signal based on the input signal. In some embodiments, the first register may be clocked such that the first signal has a sample symbol rate that is less than the input symbol rate.

The second path may be configured to receive the input signal. The second path may include a second register configured to output a second signal based on the input signal. In some embodiments, the second register may be clocked such that the second signal has the sample symbol rate.

The summation circuit may be positioned between the input node and the first path and positioned between the input node and the second path. The summation circuit may be configured to receive the first signal and the second signal at the sample symbol rate and to subtract the first signal and the second signal from the input signal before the input signal is provided to the first path and the second path.

The objects and advantages of the embodiments will be realized and achieved at least by the elements, features, and combinations particularly pointed out in the claims.

It is to be understood that both the foregoing general description and the following detailed description are given as examples, are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1a is a data transmission system with an example decision feedback equalizer circuit;

FIG. 1b illustrates a timing diagram for the example decision feedback equalizer circuit of FIG. 1a;

FIG. 1c illustrates another example decision feedback equalizer circuit;

FIG. 2 illustrates another example decision feedback equalizer circuit;

FIG. 3 illustrates another example decision feedback equalizer circuit; and

FIG. 4 is a flowchart of an example method of signal equalization.

### DESCRIPTION OF EMBODIMENTS

According to some embodiments described in the present disclosure, a data transmission system may include a transmitter, a receiver, and a data channel coupled between the receiver and the transmitter. The receiver may include a decision feedback equalizer (DFE) circuit. The DFE circuit may be configured to receive a signal from the data channel. In some embodiments, the DFE circuit may be configured to compensate for post-cursor inter-symbol interference (ISI) for a current symbol of the signal that is caused by transmission of the signal along the data channel. For example, the post-cursor ISI of the current symbol may result from interference from previous symbols of the signal.

The DFE circuit may be configured to compensate for the post-cursor ISI using the logic values of the previous symbols. In these and other embodiments, using the logic values of the previous symbols, the DFE circuit may determine the post-cursor ISI contributed by each of the previous symbols. The contribution of the post-cursor ISI to the current symbol by each of the previous symbols may then be canceled out by subtracting the post-cursor ISI contributions of the previous symbols from the current symbol.

In some embodiments, the DFE circuit may be an N-way interleaved DFE circuit. As a result, the DFE circuit may include N number of paths. Each of the paths may be configured to sample the signal at a lower sampling rate than a symbol rate of the signal such that the symbols on the paths have a lower symbol rate than the symbol rate of the signal. The lower sampling rates and sampling times of the paths may be configured such that the samples on the N number of paths may be interleaved to reform the signal.

In some embodiments, each of the paths may provide multiple previous samples of the signal. In these and other embodiments, the DFE circuit may be configured to apply coefficients to the previous samples and subtract the previous samples from the signal before the signal is provided to the paths. The previous samples may be subtracted from the signal at their lower symbol rate. In contrast, some previous DFE circuits would generate previous samples at a lower symbol rate than the symbol rate of the signal and then interleave the previous samples to generate a feedback signal at the same symbol rate as the signal. For example, the previous DFE circuits would use multiplexers to interleave the previous samples to generate the feedback signal. The feedback signal at the symbol rate of the signal would be subtracted from the signal to remove the post-cursor ISI from the signal.

The DFE circuits described in this disclosure may not use multiplexers or other circuit elements to generate feedback signals at the same symbol rate as the signal. Rather, in some of the example DFE circuits described in the present disclosure, the previous symbols feedback to the signal may be feedback at a lower symbol rate than the symbol rate of the signal. As a result, the DFE circuits described in the current disclosure may consume less power, may reduce speed bottlenecks due to the implementation of the circuit element to interleave the previous symbols at the symbol rate of the signal, and may reduce a physical footprint of the DFE circuits.

Embodiments of the present disclosure are now explained with reference to the accompanying drawings.

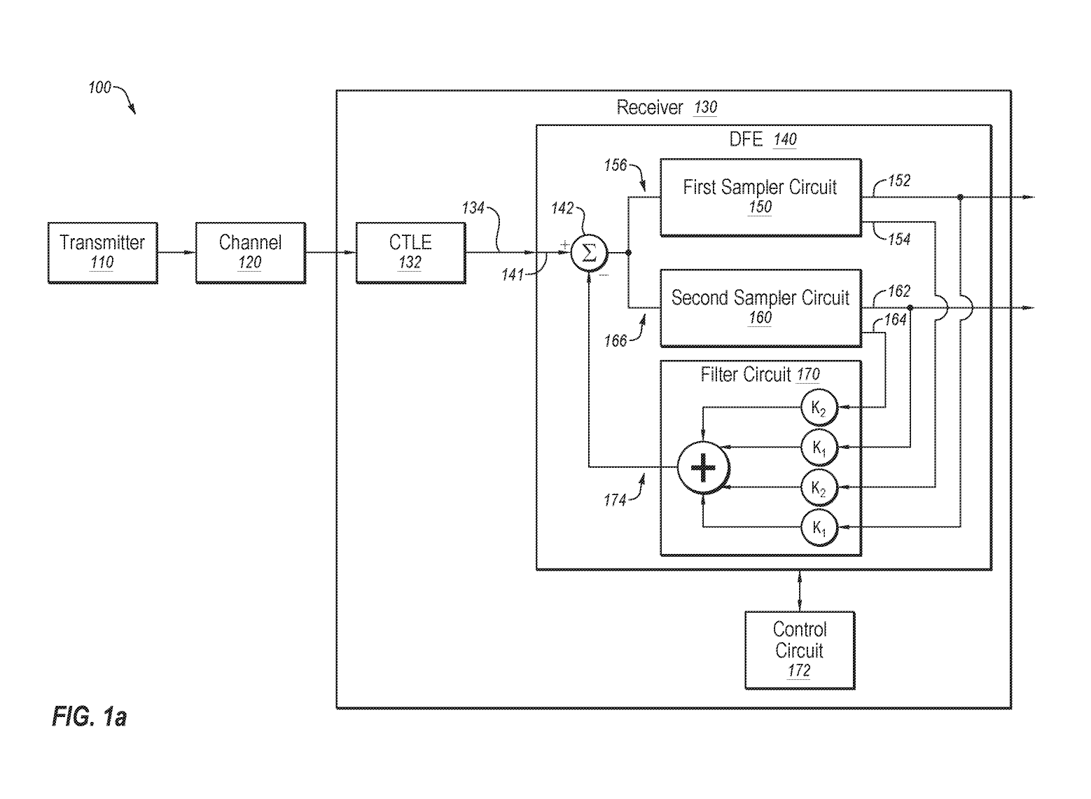

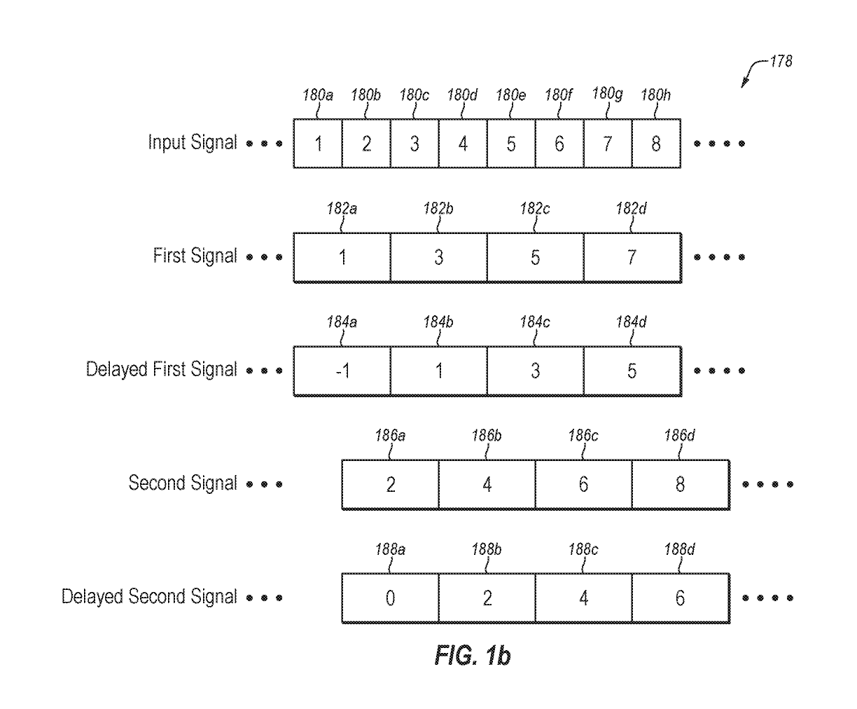

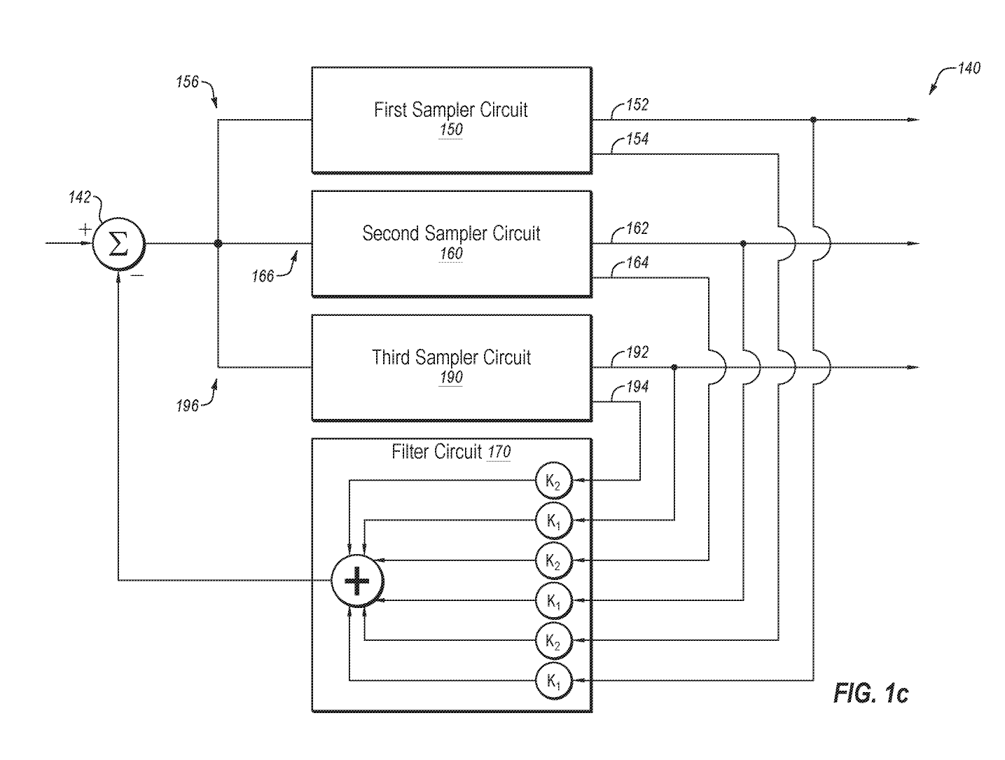

FIG. 1a is a transmission system 100 with an example decision feedback equalizer circuit 140, according to at least one embodiment of the present disclosure. The transmission system 100 may include a transmitter circuit 110, a channel 120, and a receiver circuit 130.

The transmitter circuit 110 may be configured to transmit a signal modulated with symbols. The signal may have a symbol rate. The symbol rate of the signal may refer to a number of symbols that the signal may carry over a time period. For example, a symbol rate of one gigabaud may indicate that the signal may carry one billion symbols per second. A symbol may be a representation of data. For example, a symbol may represent one of multiple logic values, which may represent one or more bits of information. For example, a symbol may represent one bit of information that is represented by two states. Alternately or additionally, a symbol may represent two or more bits of information that are represented by four or more states.

The transmitter circuit 110 may be coupled to the channel 120. The channel 120 may receive and carry the transmitted signal. The signal may be changed as it passes along the channel 120. For example, the gain of frequency components of the signal may change differently. Alternately or additionally, the symbols may interfere with each other. For example, for a given symbol, the symbols before and after the given symbol may affect or interfere with the given symbol. The interference may be referred to as pre-cursor ISI and post-cursor ISI. The channel 120 may be coupled to the receiver circuit 130 and may be configured to provide the signal with the pre- and post-cursor ISI to the receiver circuit 130.

The receiver circuit 130 may be configured to receive the signal with the pre- and post-cursor ISI, to compensate for the pre-cursor ISI, the post-cursor ISI, or both the pre-cursor ISI and the post-cursor ISI and to output the compensated signal.

In some embodiments, the receiver circuit 130 may include a continuous time linear equalizer (CTLE) circuit 132 and the DFE circuit 140. The CTLE circuit 132 may be configured to receive the signal from the channel and to compensate for the pre- and post-cursor ISI in a long range. The CTLE circuit 132 may provide the compensated signal as an input signal 134 to the DFE circuit 140.

The DFE circuit 140 may include an input node 141, a first path 156, a second path 166, and a feedback path 174. A summation circuit 142 may be coupled between the input node 141 and the first path 156 and between the input node 141 and the second path 166. The feedback path 174 may be configured to feed signals from the first path 156 and signals from the second path 166 to the summation circuit 142.

The input node 141 may be coupled to the summation circuit 142. The input node 141 may be configured to receive the input signal 134 from the CTLE circuit 132. The input signal 134 may be provided to the summation circuit 142. The summation circuit 142 may be configured to subtract the signals from the first path 156 and signals from the second path 166 on the feedback path 174, referred to as a feedback signal, from the input signal 134.

In some embodiments, the feedback signal may be a signal that represents the post-cursor ISI at a specific timing in a short range of the input signal 134. In these and other embodiments, the output of the summation circuit 142 may be the input signal 134 for which the post-cursor ISI is partially or wholly compensated or removed. In some embodiments, the feedback signal may be an analog signal.

The summation circuit 142 may be coupled to the first path 156 and the second path 166. As a result, a signal output by the summation circuit 142 may be provided to both the first path 156 and to the second path 166.

The first path 156 may include a first sampler circuit 150. The first sampler circuit 150 may be configured to sample and quantize the input signal 134 from the summation circuit 142. In some embodiments, the first sampler circuit 150 may be configured to convert the input signal 134 received from the summation circuit 142 to a digital signal. For example, the first sampler circuit 150 may determine when a level of the input signal 134 is above a threshold value. When the level of the input signal 134 is above a threshold, the first sampler circuit 150 may output a logical one for the digital signal. Otherwise, the first sampler circuit 150 may output a logical zero for the digital signal. In some embodiments, the first sampler circuit 150 may be an analog-to-digital converter circuit or some other quantizer circuit.

The first sampler circuit 150 may be configured to output a first signal 152 based on the samples of the input signal 134. In some embodiments, the first sampler circuit 150 may be configured to sample and quantize the input signal 134 at a sample rate that is less than the symbol rate of the input signal 134. As a result, the first signal 152 may have a symbol rate that is less than the symbol rate of the input signal 134. In some embodiments, the symbol rate of the first signal 152 may depend on the number of paths in the DFE circuit 140. For example, for N number of paths, the symbol rate of the first signal 152 may be 1/N of the symbol rate of the input signal 134. In the DFE circuit 140, there are two paths. As a result, the symbol rate of the first signal 152 may be one-half the symbol rate of the input signal 134. The first signal 152 may be provided to the feedback path 174 and may be an output of the receiver circuit 130.

The first sampler circuit 150 may be further configured to output a delayed first signal 154. The delayed first signal 154 may be a delayed version of the first signal 152. For example, for a given symbol in the first signal 152, the delayed first signal 154 may be a symbol that came before the given symbol in the first signal 152. Further explanation regarding the relationship between the first signal 152 and the delayed first signal 154 is provided with respect to FIG. 1b. The first sampler circuit 150 may be configured to provide the delayed first signal 154 to the feedback path 174.

The second path 166 may include a second sampler circuit 160. The second sampler circuit 160 may be configured to sample and quantize the input signal 134 from the summation circuit 142. In some embodiments, the second sampler circuit 160 may be a circuit analogous to the first sampler circuit 150. Alternately or additionally, the second sampler circuit 160 may be a different circuit than the first sampler circuit 150.

The second sampler circuit 160 may be configured to output a second signal 162 based on the samples of the input signal 134. In some embodiments, the second sampler circuit 160 may be configured to sample and quantize the input signal 134 at a sample rate that is less than the symbol rate of the input signal 134. As a result, the second signal 162 may have a symbol rate that is less than the symbol rate of the input signal 134. The second signal 162 may be provided to the feedback path 174 and may be an output of the receiver circuit 130.

In some embodiments, the second sampler circuit 160 may sample the input signal 134 at the same rate as the first sampler circuit 150 samples the input signal 134. Thus, in the DFE circuit 140, the second sampler circuit 160 may sample the input signal 134 at half the rate of the symbol rate of the input signal 134 such that the second signal 162 has a symbol rate that is one-half the symbol rate of the input signal 134.

In these and other embodiments, the first sampler circuit 150 may sample the input signal 134 at a time interval that is offset from when the second sampler circuit 160 may sample the input signal 134. Thus, the first signal 152 and the second signal 162 may each carry one-half of the symbols of the input signal 134. In some embodiments, the first signal 152 and the second signal 162 may carry alternating symbols of the input signal 134 such that the first signal 152 and the second signal 162 may be combined to form the input signal 134.

The second sampler circuit 160 may be further configured to output a delayed second signal 164. The delayed second signal 164 may be a delayed version of the second signal 162. For example, for a given symbol in the second signal 162, the delayed second signal 164 may be a symbol that came before the given symbol in the second signal 162. The second sampler circuit 160 may be configured to provide the delayed second signal 164 to the feedback path 174.

FIG. 1b illustrates a timing diagram 178 for the DFE circuit 140 of FIG. 1a, according to at least one embodiment of the present disclosure. The timing diagram 178 may illustrate a relationship between the input signal 134, the first signal 152, and the second signal 162. The timing diagram 178 may also illustrate a relationship between the first signal 152 and the delayed first signal 154 and a relationship between the second signal 162 and the delayed second signal 164.

The timing diagram 178 illustrates various symbol intervals for the input signal 134, the first signal 152, the delayed first signal 154, the second signal 162, and the delayed second signal 164 and the symbol in each of the symbol intervals. For example, the timing diagram 178 illustrates first, second, third, fourth, fifth, sixth, seventh, and eighth symbol intervals 180a-180h, referred to collectively as the symbol intervals 180, of the input signal 134. Each of the symbol intervals 180 include a number that corresponds to a symbol in the input signal 134 for that given symbol interval 180.

The timing diagram 178 further illustrates, first, second, third, and fourth symbol intervals 182a-182d, referred to collectively as the symbol intervals 182, of the first signal 152; first, second, third, and fourth symbol intervals 184a-184d, referred to collectively as the symbol intervals 184, of the delayed first signal 154; the first, second, third, and fourth symbol intervals 186a-186d, referred to collectively as the symbol intervals 186, of the second signal 162; and the first, second, third, and fourth symbols 188a-188d, referred to collectively as the symbol intervals 188, of the delayed second signal 164. Each of the symbol intervals 182, the symbol intervals 184, the symbol intervals 186, and the symbol intervals 188 also include a number that corresponds to a symbol in each of the symbol intervals.

As described with respect to FIG. 1a, the first signal 152 and the second signal 162 may have a symbol rate that is one-half the symbol rate of the input signal 134. As a result, the symbol interval of the first signal 152 and the second signal 162 may be twice the length of time as the symbol interval of the input signal 134. Further, as illustrated in the timing diagram 178, the first signal 152 and the second signal 162 may carry alternating symbols of the input signal 134. For example, the first signal 152 may carry symbols 1, 3, 5, and 7 and the second signal 162 may carry symbols 2, 4, 6, and 8. Further as illustrated, the first signal 152 and the second signal 162 may be interleaved to reform the input signal 134.

The timing diagram 178 further illustrates a delayed relationship between the first signal 152 and the delayed first signal 154. The symbol intervals of the first signal 152 and the delayed first signal 154 are the same length of time. Additionally, the symbols in the first signal 152 and the delayed first signal 154 are the same, except the symbols in the first signal 152 are delayed with respect to the symbols in the delayed first signal 154. For example, for corresponding symbol intervals, such as 182a and 184b, the symbol for the delayed first signal 154 is the symbol from the previous symbol interval for the first signal 152. Thus, the delayed first signal 154 is a delayed version of the first signal 152.

The timing diagram 178 further illustrates the delayed relationship between the second signal 162 and the delayed second signal 164 that is analogous to the delayed relationship between the first signal 152 and the delayed first signal 154.

Returning to FIG. 1a, the feedback path 174 may include a filter circuit 170. The filter circuit 170 may be configured to receive the first signal 152, the delayed first signal 154, the second signal 162, and the delayed second signal 164. The filter circuit 170 may apply a multiplier coefficient to each of the first signal 152, the delayed first signal 154, the second signal 162, and the delayed second signal 164. In some embodiments, application of a multiplier coefficient by the filter circuit 170 may include the filter circuit 170 multiplying the first signal 152, the delayed first signal 154, the second signal 162, and the delayed second signal 164 by a coefficient. Application of a coefficient to each of the first signal 152, the delayed first signal 154, the second signal 162, and the delayed second signal 164 may change an amplitude of the first signal 152, the delayed first signal 154, the second signal 162, and the delayed second signal 164.

In some embodiments, a first multiplier coefficient K1 may be applied to the first signal 152 and the second signal 162 and a second multiplier coefficient K2 may be applied to the delayed first signal 154 and the delayed second signal 164. In some embodiments, each signal that is provided to the filter circuit 170 that has a similar delay from the input signal 134 may have the same multiplier coefficient applied. In some embodiments, the multiplier coefficients provided to signals with different delays may be different multiplier coefficients. For example, the first multiplier coefficient may be different than the second multiplier coefficient. The multiplier coefficients may be different because a signal delayed more than another signal from a given signal may contribute different amounts of post-cursor ISI to the given symbol.

In some embodiments, the filter circuit 170 may sum the first signal 152, the delayed first signal 154, the second signal 162, and the delayed second signal 164 after application of the multiplier coefficients. The sum may be provided to the summation circuit 142 as the feedback signal that is subtracted from the input signal 134. Alternately or additionally, the filter circuit 170 may provide the first signal 152, the delayed first signal 154, the second signal 162, and the delayed second signal 164 after application of the multiplier coefficients to the summation circuit 142 for subtracting from the input signal 134. In these and other embodiments, the first signal 152, the delayed first signal 154, the second signal 162, and the delayed second signal 164 after application of the multiplier coefficients may form the feedback signal.

Note that the first signal 152, the delayed first signal 154, the second signal 162, and the delayed second signal 164 are summed and provided as the feedback signal to the summation circuit 142 at a symbol rate that is one-half the symbol rate of the input signal 134. The filter circuit 170 does not generate a feedback signal with a symbol rate that matches the symbol rate of the input signal 134 to provide to the summation circuit 142 for subtracting from the input signal 134.

In some embodiments, multiplier coefficients used by the filter circuit 170 may range between 0.0 and 1.0. In some embodiments, the multiplier coefficients applied by the filter circuit 170 may be selected based on the post-cursor ISI of the input signal 134. In these and other embodiments, the coefficients may be determined based on how the channel 120 affects a signal transmitted by the transmitter circuit 110.

In some embodiments, the filter circuit 170 may be a finite impulse response (FIR) filter. In these and other embodiments, the multiplier coefficients may be selected based on the filtering for FIR filter. Additional details regarding the selection of the multiplier coefficients are provided hereafter. In some embodiments, the filter circuit 170 may be an infinite impulse response (IIR) filter. In these and other embodiments, the filter circuit 170 may include additional elements such as a low pass filters. In some embodiments, the filter circuit 170 may be another type of filter.

In some embodiments, the receiver circuit 130 may include a control circuit 172. The control circuit 172 may be coupled to the DFE circuit 140 and may be configured to set, adjust, or otherwise control the coefficients of the filter circuit 170.

Modifications, additions, or omissions may be made to FIG. 1a without departing from the scope of the present disclosure. For example, in some embodiments the receiver circuit 130 may not include the CTLE circuit 132. Alternately or additionally, the receiver circuit 130 may not include the control circuit 172. Alternately or additionally, a first summation circuit may be located between the filter circuit 170 and the first sampler circuit 150 and the second sampler circuit 160 and configured to sum the first signal 152 and the second signal 162. Alternately or additionally, a second summation circuit may be located between the filter circuit 170 and the first sampler circuit 150 and the second sampler circuit 160 and configured to sum the delayed first signal 154 and the delayed second signal 164.

Alternately or additionally, the DFE circuit 140 may include one or more additional paths. For example, FIG. 1c illustrates the DFE circuit with a third path 196 coupled between the summation circuit 142 and the filter circuit 170, according to at least one embodiment of the present disclosure. The third path 196 may include a third sampler circuit 190. The third sampler circuit 190 may be configured to sample and quantize the input signal 134. In some embodiments, the third sampler circuit 190 may be a circuit analogous to the first and second sampler circuits 150 and 160. Alternately or additionally, the third sampler circuit 190 may be a different circuit than the first and second sampler circuits 150 and 160.

The third sampler circuit 190 may be configured to output a third signal 192 based on the samples of the input signal 134. In some embodiments, the third sampler circuit 190 may be configured to sample the input signal 134 at a sample rate that is less than the symbol rate of the input signal 134. With three paths, each of the first sampler circuit 150, the second sampler circuit 160, and the third sampler circuit 190 may sample the input signal 134 at one-third of the symbol rate of the input signal 134. Furthermore, each of the first sampler circuit 150, the second sampler circuit 160, and the third sampler circuit 190 may sample the input signal 134 at offsetting time periods such that each of the first sampler circuit 150, the second sampler circuit 160, and the third sampler circuit 190 may sample each third symbol of the input signal 134.

The third sampler circuit 190 may be further configured to output a delayed third signal 194 to the filter circuit 170. The delayed third signal 194 may be a delayed version of the third signal 192. The filter circuit 170 may apply a multiplier coefficient to the third signal 192 and the delayed third signal 194. After application of the multiplier coefficient, the filter circuit 170 may sum the third signal 192 and the delayed third signal 194 with the first signal 152, the delayed first signal 154, the second signal 162, and the delayed second signal 164 to form a feedback signal to provide to the summation circuit 142. In some embodiments, the first multiplier coefficient applied to the first signal 152 and the second signal 162 may be applied to the third signal 192. Alternately or additionally, the second multiplier coefficient applied to the delayed first signal 154 and the delayed second signal 164 may be applied to the delayed third signal 194.

Modifications, additions, or omissions may be made to FIG. 1c, without departing from the scope of the present disclosure. For example, the DFE circuit 140 may include additional paths that provide outputs to the filter circuit 170 for generating a feedback signal at a symbol rate lower than the symbol rate of the input signal 134. The feedback signal may be provided to the summation circuit 142 for subtraction from the input signal 134.

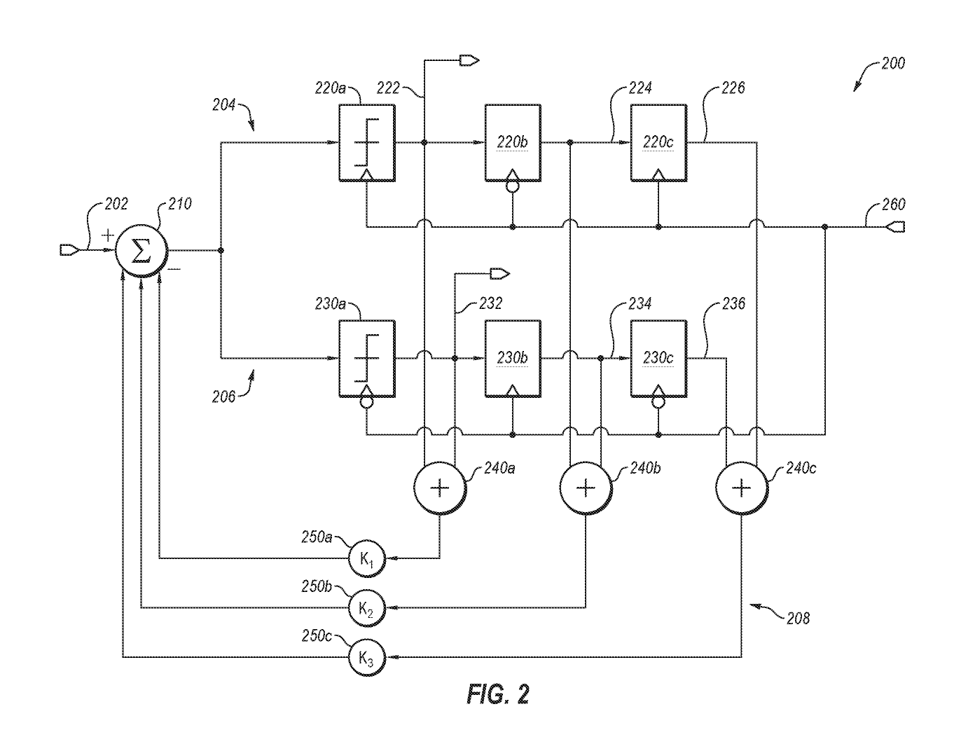

FIG. 2 illustrates another example DFE circuit 200, according to at least one embodiment of the present disclosure. The DFE circuit 200 may include an input node 202, a summation circuit 210, a first path 204, a second path 206, and a feedback path 208. The input node 202 may be coupled to the summation circuit 210. The summation circuit 210 may be coupled to the first path 204, the second path 206, and the feedback path 208.

In general, the input node 202 may receive an input signal. The input signal may have a symbol rate and a symbol time interval for the length of each of the symbols. The input node 202 may provide the input signal to the summation circuit 210. The summation circuit 210 may receive the input signal and subtract a feedback signal along the feedback path 208 from the input signal. The output of the summation circuit 210 may be provided to the first path 204 and the second path 206.

The first path 204 and the second path 206 may be configured to generate signals that have a symbol rate that is less than the symbol rate of the input signal. For example, the first path 204 and the second path 206 may generate signals that have a symbol rate that is one-half of the symbol rate of the input signal. The first path 204 and the second path 206 may each generate multiple signals at the lower symbol rate. Some of the signals may be delayed versions of each other. The signals may be provided to the feedback path 208. The feedback path 208 may apply multiplier coefficients to the signals and provide the signals with the applied multiplier coefficients to the summation circuit 210 as the feedback signal.

The first path 204 may include a first path first register 220a, a first path second register 220b, and a first path third register 220c, referred to collectively as the first path registers 220. The first path first register 220a may be configured to receive the input signal from the summation circuit 210. The first path first register 220a may sample and quantize the input signal.

The first path registers 220 may be clocked by a clock signal 260. The clock signal 260 may have a rate that is one-half the symbol rate of the input signal. As a result, the first path first register 220a may sample every other of the symbols of the input signal at a rising edge of the clock signal 260. The first path first register 220a may output the sample of every other symbol of the input signal as a first path first register signal 222. The first path first register signal 222 may be provided to the first path second register 220b and to a first summer circuit 240a. Additionally, the first path first register signal 222 may be an output of the DFE circuit 200.

The first path second register 220b may sample every symbol of the first path first register signal 222 at a falling edge of the clock signal 260. The first path second register 220b may output the sample of the first path first register signal 222 as a first path second register signal 224. The first path second register signal 224 may be a delayed version of the first path first register signal 222 that is delayed by a length of time equal to the symbol interval of the input signal or one-half the rate of the clock signal 260. The first path second register signal 224 may be provided to the first path third register 220c and to a second summer circuit 240b.

The first path third register 220c may sample every symbol of the first path second register signal 224 at a rising edge of the clock signal 260. The first path third register 220c may output the sample of the first path second register signal 224 as a first path third register signal 226. The first path third register signal 226 may be a delayed version of the first path second register signal 224 that is delayed by a length of time equal to the symbol interval of the input signal or one-half the rate of the clock signal 260. The first path third register signal 226 may be provided to the third summer circuit 240c.

The second path 206 may include a second path first register 230a, a second path second register 230b, and a second path third register 230c, referred to collectively as the second path registers 230. The second path first register 230a may be configured to receive the input signal from the summation circuit 210. The second path first register 230a may be further configured to sample and quantize the input signal.

The second path registers 230 may be clocked by the clock signal 260. The second path first register 230a may sample every other of the symbols of the input signal at a falling edge of the clock signal 260. As a result, the second path first register 230a may sample alternating symbols with the first path first register 220a, such that the first path first register 220a and the second path first register 230a sample all of the symbols of the input signal.

The second path first register 230a may output the sample of every other symbol of the input signal as a second path first register signal 232. The second path first register signal 232 may be provided to the second path second register 230b and to the first summer circuit 240a. Additionally, the second path first register signal 232 may be an output of the DFE circuit 200.

The second path second register 230b may sample every symbol of the second path first register signal 232 at a rising edge of the clock signal 260. The second path second register 230b may output the sample of the second path first register signal 232 as a second path second register signal 234. The second path second register signal 234 may be a delayed version of the second path first register signal 232 that is delayed by a length of time equal to the symbol interval of the input signal or one-half the rate of the clock signal 260.

The second path second register signal 234 may be provided to the second path third register 230c and to the second summer circuit 240b.

The second path third register 230c may sample every symbol of the second path second register signal 234 at a falling edge of the clock signal 260. The second path third register 230c may output the sample of the second path second register signal 234 as a second path third register signal 236. The second path third register signal 236 may be a delayed version of the second path second register signal 234 that is delayed by a length of time equal to the symbol interval of the input signal or one-half the rate of the clock signal 260. The second path third register signal 236 may be provided to the third summer circuit 240c.

The feedback path 208 may include the first summer circuit 240a, the second summer circuit 240b, and the third summer circuit 240c, collectively referred to as the summer circuits 240. The feedback path 208 may further include a first coefficient 250a, a second coefficient 250b, and a third coefficient 250c, referred to collectively as the coefficients 250. The coefficients 250 may form a filter circuit, such as the filter circuit 170 of FIG. 1. In some embodiments, the coefficients 250 may form a FIR filter or an IIR filter.

The first summer circuit 240a may receive the first path first register signal 222 and the second path first register signal 232. The first summer circuit 240a may be configured to sum the first path first register signal 222 and the second path first register signal 232. The sum may be provided to the first coefficient 250a.

The second summer circuit 240b may receive the first path second register signal 224 and the second path second register signal 234. The second summer circuit 240b may be configured to sum the first path second register signal 224 and the second path second register signal 234. The sum may be provided to the second coefficient 250b.

The third summer circuit 240c may receive the first path third register signal 226 and the second path third register signal 236. The third summer circuit 240c may be configured to sum the first path third register signal 226 and the second path third register signal 236. The sum may be provided to the third coefficient 250c.

The sum from the first summer circuit 240a may be multiplied by a multiplier coefficient K1 of the first coefficient 250a. After multiplying the sum by the multiplier coefficient K1, the multiplied sum may be provided to the summation circuit 210 to be subtracted from the input signal.

The sum from the second summer circuit 240b may be multiplied by a multiplier coefficient K2 of the second coefficient 250b. After multiplying the sum by the multiplier coefficient K2, the multiplied sum may be provided to the summation circuit 210 to be subtracted from the input signal.

The sum from the third summer circuit 240c may be multiplied by a multiplier coefficient K3 of the third coefficient 250c. After multiplying the sum by the multiplier coefficient K3, the multiplied sum may be provided to the summation circuit 210 to be subtracted from the input signal.

The signals summed by the summer circuits 240 and multiplied by the same multiplier coefficients may have similar delays. For example, the first path first register signal 222 and the second path first register signal 232, which are both samples of the input signal are summed together and multiplied by the coefficient K1. Likewise, samples of the input signal that are delayed a similar amount, such as the first path second register signal 224 and the second path second register signal 234 may be summed together and may be multiplied by the same multiplier coefficient K2.

Furthermore, the signals that have similar delays may be signals with symbols that would be consecutive symbols from the input signal. Thus, the signals that may be multiplied by the same multiplier coefficient may have symbols that were consecutive symbols in the input signal.

In some embodiments, the first path 204 and the second path 206 may each include more or less registers. For example, in some embodiments, the first path 204 and the second path 206 may each include one, two, four, five, six, or more registers. In some embodiments, the number of registers in each of the first path 204 and the second path 206 may be referred to as a number of taps of the DFE circuit 200. For example, a five tap DFE circuit may refer to the DFE circuit 200 including five registers in each of the first path 204 and the second path 206.

The feedback signal of the feedback path 208 may be provided to the summation circuit 210 with a symbol rate that is one-half the symbol rate of the input signal. The feedback signal may have a symbol rate that is one-half the symbol rate of the input signal based on the signals output by the first path registers 220 and the second path registers 230 having symbol rates that are one-half the symbol rate of the input signal. By providing the feedback signal at one-half the symbol rate of the input signal, the DFE circuit 200 may not include multiplexers or other circuitry to generate a feedback signal with a symbol rate equal to the symbol rate of the input signal.

In some embodiments, the feedback signal having a symbol rate that is one-half the symbol rate of the input signal may result in the DFE circuit 200 having one fewer registers or taps than other DFE circuits that generate a feedback signal with a symbol rate equal to the symbol rate of the input signal. For example, for a desired result, the DFE circuit 200 may achieve the result using one fewer tap or register per path than other DFE circuits.

In some embodiments, the multiplier coefficients of the coefficients 250 may be determined based on coefficients used for previous DFE circuits. For example, a training signal may be provided to a DFE circuit and a zero-forcing or least mean square technique may be used to determine the coefficients using previous techniques.

For example, the following equation may represent an operation of a previous five tap DFE circuit:

yᵢ=xᵢ−C₁×aᵢ₋₁−C₂×aᵢ₋₂−C₃×aᵢ₋₃−C₄×aᵢ₋₄−C₅×aᵢ₋₅

where the yᵢ is the signal output by a circuit analogous to the summation circuit 210, xᵢ is in the input signal, C₁ through C₅ are the multiplier coefficients and aᵢ₋₁ through aᵢ₋₅ are the previous symbol values of the input signal which are carried by the signals output by the registers or taps of the DFE circuit.

The multiplier coefficients C₁ through C₅ may be used to determine the multiplier coefficient values of the DFE circuit 200 with four taps. The DFE circuit 200 with four taps or registers in each of the first path 204 and the second path 206 may be represented by the following equation:

ŷᵢ=xᵢ−K₁×(aᵢ₋₁+aᵢ₋₂)−K₂×(aᵢ₋₂+aᵢ₋₃)−K₃×(aᵢ₋₃+aᵢ₋₄)−K₄×(aᵢ₋₄+aᵢ₋₅)

where ŷᵢ is the signal output by the summation circuit 210, xᵢ is in the input signal, K₁ through K₄ are the multiplier coefficients of the coefficients 250, and aᵢ₋₁ through aᵢ₋₅ are the previous symbol values of the signals provided by the first path 204 and the second path 206.

The equation for the DFE circuit 200 may be rewritten as the following:

ŷᵢ=xᵢ−K₁×aᵢ₋₁−(K₁+K₂)×aᵢ₋₂−(K₂+K₃)×aᵢ₋₃−(K₃+K₄)×aᵢ₋₄−K₄×aᵢ₋₅

which may be approximately equal to:

xᵢ−C₁×aᵢ₋₁−C₂×aᵢ₋₂−C₃×aᵢ₋₃−C₄×aᵢ₋₄−C₅×aᵢ₋₅

which is the equation of the previous five tap DFE circuit.

Based on this approximation, the following may be determined which minimizes the sum of the squared error between the result of the DFE circuit 200 and the conventional DFE circuit:

$$[ \begin{matrix}{C}_{1} \\ {C}_{2} \\ {C}_{3} \\ {C}_{4} \\ {C}_{5}\end{matrix} ] \approx [ \begin{matrix}1 & 0 & 0 & 0 \\ 1 & 1 & 0 & 0 \\ 0 & 1 & 1 & 0 \\ 0 & 0 & 1 & 1 \\ 0 & 0 & 0 & 1\end{matrix} ] \times [ \begin{matrix}{K}_{1} \\ {K}_{2} \\ {K}_{3} \\ {K}_{4}\end{matrix} ] = A \times [ \begin{matrix}{K}_{1} \\ {K}_{2} \\ {K}_{3} \\ {K}_{4}\end{matrix} ]$$

from the above, the following may be determined:

$$[ \begin{matrix}{K}_{1} \\ {K}_{2} \\ {K}_{3} \\ {K}_{4}\end{matrix} ] \approx {A}^{+} \times [ \begin{matrix}{C}_{1} \\ {C}_{2} \\ {C}_{3} \\ {C}_{4} \\ {C}_{5}\end{matrix} ] = {( {A}^{T} A )}^{- 1} {A}^{T} \times [ \begin{matrix}{C}_{1} \\ {C}_{2} \\ {C}_{3} \\ {C}_{4} \\ {C}_{5}\end{matrix} ] = \frac{1}{5} [ \begin{matrix}4 & 1 & - 1 & 1 & - 1 \\ - 3 & 3 & 2 & - 2 & 2 \\ 2 & - 2 & 2 & 3 & - 3 \\ - 1 & 1 & - 1 & 1 & 4\end{matrix} ] \times [ \begin{matrix}{C}_{1} \\ {C}_{2} \\ {C}_{3} \\ {C}_{4} \\ {C}_{5}\end{matrix} ]$$

where A⁺ is a pseudoinverse of the matrix A and A^{T} is the transpose of the matrix A.

In some embodiments, using the above equation or analogous equations, the multiplier coefficients of the coefficients 250 may be determined.

Modifications, additions, or omissions may be made to the DFE circuit 200 without departing from the scope of the present disclosure. For example, in some embodiments the DFE circuit 200 may include a low-pass filter between each of the summer circuits 240 and the coefficients 250. Alternately or additionally, the DFE circuit 200 may include additional paths in an analogous manner as illustrated in FIG. 1c.

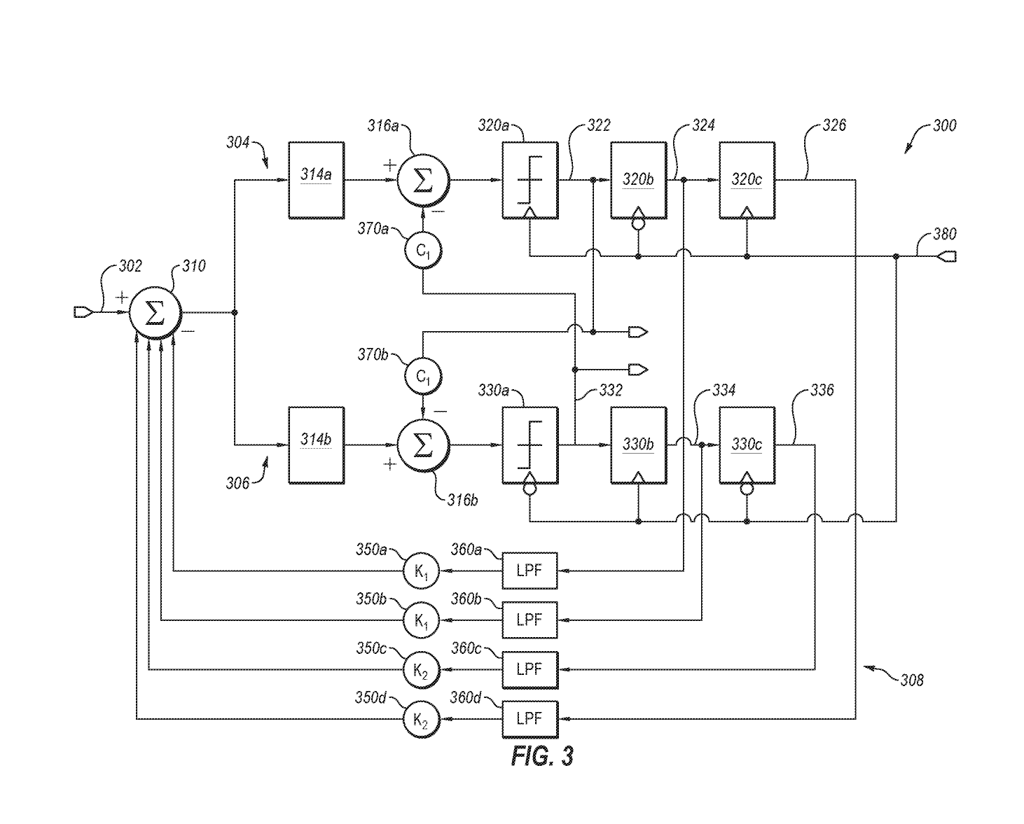

FIG. 3 illustrates another example DFE circuit 300, according to at least one embodiment of the present disclosure. The DFE circuit 300 may include an input node 302, a summation circuit 310, a first path 304, a second path 306, and a feedback path 308. The input node 302 may be coupled to the summation circuit 310. The summation circuit 310 may be coupled to the first path 304, the second path 306, and the feedback path 308.

The DFE circuit 300 may operate in a manner analogous to the DFE circuit 200 in that the first path 304 and the second path 306 may provide signals to the feedback path 308 for the feedback path 308 to provide to the summation circuit 310 to subtract from an input signal received at the summation circuit 310 from the input node 302.

The feedback path 308 may include a first low pass filter circuit 360a, a second low pass filter circuit 360b, a third low pass filter circuit 360c, and a fourth low pass filter circuit 360d, referred to collectively as the low pass filter circuits 360. The feedback path 308 may further include a first coefficient 350a, a second coefficient 350b, a third coefficient 350c, and a fourth coefficient 350d, referred to collectively as the coefficients 350. The low pass filter circuits 360 and the coefficients 350 may be part of a filter circuit, such as an IIR filter circuit.

The first path 304 may include a first path first register 320a, a first path second register 320b, and a first path third register 320c, referred to collectively as the first path registers 320, a first buffer circuit 314a, and a first summer circuit 316a. The first buffer circuit 314a may be configured to isolate the elements of the first path 304 from the second path 306. In some embodiments, the first buffer circuit 314a may be an amplifier, sampler circuit, or some other circuit. The first buffer circuit 314a may provide a buffered input signal to the first summer circuit 316a.

The first summer circuit 316a may be configured to receive the buffered input signal. The first summer circuit 316a may be further configured to receive a second path first register signal 332 after application of a direct coefficient C1 by a first direct coefficient 370a. The first summer circuit 316a may subtract the second path first register signal 332 multiplied with the direct coefficient C1 from the buffered input signal. The resulting signal may be provided to the first path first register 320a.

The first path first register 320a may be configured to receive the signal from the first summer circuit 316a. The first path first register 320a may sample and quantize the signal from the first summer circuit 316a.

The first path registers 320 may operate in a similar manner as the first path registers 220 of FIG. 2. In these and other embodiments, the first path registers 320 may be clocked by a clock signal 380 to generate a first path first register signal 322, a first path second register signal 324, and a first path third register signal 326. The first path first register signal 322 may be provided to a second summer circuit 316b after application of a direct coefficient C1 by a second direct coefficient 370b and may be an output of the DFE circuit 300. The first path second register signal 324 may be provided to a first low pass filter circuit 360a. The first path third register signal 326 may be provided to a fourth low pass filter circuit 360d.

The second path 306 may include a second path first register 330a, a second path second register 330b, and a second path third register 330c, referred to collectively as the second path registers 330, a second buffer circuit 314b, and a second summer circuit 316b. The second buffer circuit 314b may be analogous to the first buffer circuit 314a and may provide a buffered input signal to the second summer circuit 316b.

The second summer circuit 316b may be configured receive the buffered input signal. The second summer circuit 316b may be further configured to receive a first path first register signal 322 after applying the direct coefficient C1 by the second direct coefficient 370b. The second summer circuit 316b may subtract the first path first register signal 322 multiplied with the direct coefficient C1 from the buffered input signal. The resulting signal may be provided to the second path first register 330a.

The second path first register 330a may be configured to receive the signal from the second summer circuit 316b, sample, and quantize the signal.

The second path registers 330 may operate in an analogous manner as the second path registers 230 of FIG. 2. In these and other embodiments, the second path registers 330 may be clocked by a clock signal 380 to generate the second path first register signal 332, a second path second register signal 334, and a second path third register signal 336. The second path first register signal 332 may be provided to the first summer circuit 316a after application of the direct coefficient C1 by the first direct coefficient 370a and may be an output of the DFE circuit 300. The second path second register signal 334 may be provided to the second low pass filter circuit 360b. The second path third register signal 336 may be provided to the third low pass filter circuit 360c.

The low pass filter circuits 360 may be configured to receive the signals from the first path registers 320 and the second path registers 330. The low pass filter circuits 360 may filter the signals using low pass filters. The filtered signals may be provided to the coefficients 350.

A first multiplier coefficient K1 may be applied to the filtered signal from the first low pass filter circuit 360a by the first coefficient 350a. The multiplied signal may be provided to the summation circuit 310 for subtraction from the input signal.

The first multiplier coefficient K1 may be applied to the filtered signal from the second low pass filter circuit 360b by the second coefficient 350b. The multiplied signal may be provided to the summation circuit 310 for subtraction from the input signal.

A second multiplier coefficient K2 may be applied to the filtered signals from the third low pass filter circuit 360c and the fourth low pass filter circuit 360d by the third coefficient 350c and the fourth coefficient 350d, respectively, and the multiplied signals may be provided to the summation circuit 310 for subtraction from the input signal.

In some embodiments, the multiplier coefficients for the coefficients 350 may be determined used a similar methodology as explained above or by applying a gradient descent method to optimize the multiplier coefficients by minimizing the square sum of the residual of the post-cursor ISI of the input signal.

In a similar manner as in the DFE circuit 200, the DFE circuit 300 may apply the same multiplier coefficient to signals delayed similar amounts. In contrast, to the DFE circuit 200 of FIG. 2, the DFE circuit 300 may include six coefficients because the signals with similar delays are not summed together before being provided to the coefficients.

Modifications, additions, or omissions may be made to the DFE circuit 300 without departing from the scope of the present disclosure. For example, in some embodiments, the DFE circuit 300 may not include the low pass filter circuits 360. Alternately or additionally, the DFE circuit 300 may not include the first summer circuit 316a and the second summer circuit 316b. In these and other embodiments, a multiplier coefficient may be applied to the first path first register signal 322 and the second path first register signal 332 and the result may be feed back to the summation circuit 310. Alternately or additionally, additional signals generated by the first path registers 320 and the second path registers 330 may be provided to the first summer circuit 316a and the second summer circuit 316b.

As another example, the DFE circuit 300 may include more or fewer registers in each of the first path 304 and the second path 306. Alternately or additionally, the DFE circuit 300 may not include the first buffer circuit 314a and the second buffer circuit 314b. In some embodiments, the DFE circuit 300 may include additional paths in an analogous similar manner as illustrated in FIG. 1c.

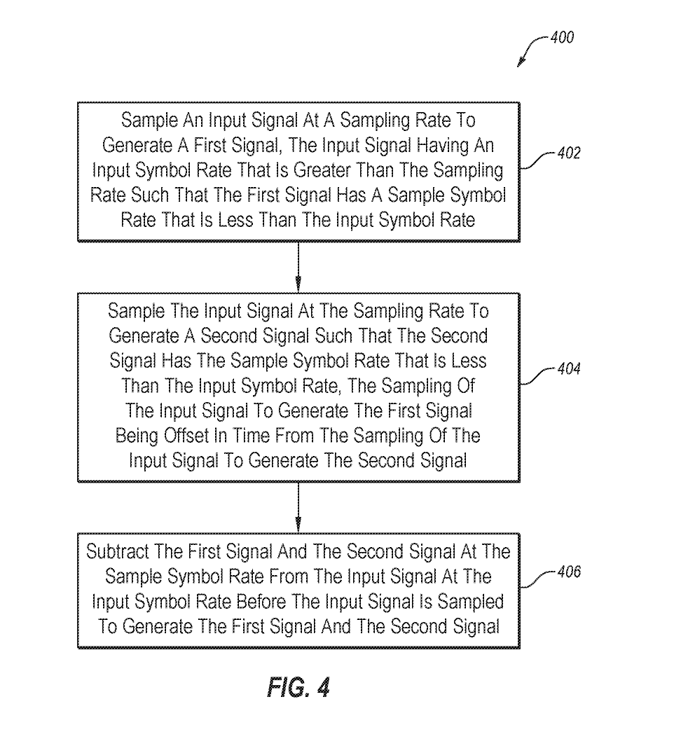

FIG. 4 is a flowchart of an example method 400 of signal equalization, arranged in accordance with at least one embodiment described in the present disclosure. The method 400 may be implemented, in some embodiments, by a decision feedback equalizer, such as one or more of the decision feedback equalizers of FIGS. 1a, 1c, 2, and 3, respectively. Although illustrated as discrete blocks, various blocks may be divided into additional blocks, combined into fewer blocks, or eliminated, depending on the target implementation.

The method 400 may begin at block 402, where an input signal may be sampled at a sampling rate to generate a first signal. The input signal may have an input symbol rate that is greater than the sampling rate such that the first signal has a sample symbol rate that is less than the input symbol rate.

At block 404, the input signal may be sampled at the sampling rate to generate a second signal such that the second signal has the sample symbol rate that is less than the input symbol rate. Sampling of the input signal to generate the first signal may be offset in time from the sampling of the input signal to generate the second signal.

At block 406, the first signal and the second signal at the sample symbol rate may be subtracted from the input signal at the input symbol rate before the input signal is sampled to generate the first signal and the second signal.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 400 may include before subtracting the first signal and the second signal, summing the first signal and the second signal. The method 400 may further include applying a multiplier coefficient to the summed first and second signal. In these and other embodiments, the summed first and second signals with the applied multiplier coefficient may be subtracted from the input signal before the input signal is sampled to generate the first signal and the second signal.

In some embodiments, the method 400 may further include applying a multiplier coefficient to the first signal and to the second signal before subtracting the first signal and the second signal. Alternately or additionally, the method 400 may further include low pass filtering the first signal and the second signal before applying the multiplier coefficient to the first signal and the second signal.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A decision feedback equalizer comprising:
an input node configured to receive an input signal with an input symbol rate;
a first path configured to receive a modified input signal that is based on the input signal and has the input symbol rate, the first path including a first register configured to output a first signal based on the modified input signal, the first register clocked such that the first signal has a sample symbol rate that is less than the input symbol rate;
a second path configured to receive the modified input signal, the second path including a second register configured to output a second signal based on the modified input signal, the second register clocked such that the second signal has the sample symbol rate; and
a summation circuit positioned between the input node and the first path and positioned between the input node and the second path, the summation circuit configured to:
subtract a modified first signal having the sample symbol rate and being based on the first signal and a modified second signal having the sample symbol rate and being based on the second signal from the input signal having the input symbol rate to generate the modified input signal, and
provide the modified input signal to the first path and the second path.

2. The decision feedback equalizer of claim 1, further comprising a filter circuit positioned between the summation circuit and the first register and the second register, the filter circuit configured to apply coefficients to the first signal and the second signal to generate the modified first signal and the modified second signal and to provide the modified first signal and the modified second signal to the summation circuit.

3. The decision feedback equalizer of claim 2, wherein the filter circuit further comprises:
a first low-pass filter circuit configured to filter the first signal; and
a second low-pass filter circuit configured to filter the second signal,
wherein the first low-pass filter circuit filters the first signal and the second low-pass filter circuit filters the second signal before the filter circuit applies the coefficients to the first signal and the second signal.

4. The decision feedback equalizer of claim 1, wherein the summation circuit is a first summation circuit, wherein the decision feedback equalizer further comprises a second summation circuit, the second summation circuit positioned between the first summation circuit and the first register and positioned between the first summation circuit and the second register and configured to sum the first signal and the second signal such that the first summation circuit subtracts the modified first signal and the modified second signal at the sample symbol rate when the modified first signal and the modified second signal are summed together.

5. The decision feedback equalizer of claim 4, further comprising a filter circuit positioned between the second summation circuit and the first summation circuit, the filter circuit configured to apply a coefficient to the first signal and the second signal after the first signal and the second signal are summed together.

6. The decision feedback equalizer of claim 4, further comprising a low-pass filter circuit positioned between the second summation circuit and the first summation circuit, the low-pass filter circuit configured to filter the first signal and the second signal after the first signal and the second signal are summed together.

7. The decision feedback equalizer of claim 1, further comprising a third path configured to receive the modified input signal, the third path including a third register configured to output a third signal based on the modified input signal, the third register clocked such that the third signal has the sample symbol rate,
wherein the summation circuit is further configured to receive a modified third signal based on the third signal at the sample symbol rate and to subtract the modified third signal from the input signal to generate the modified input signal provided to the first path, the second path, and the third path.

8. The decision feedback equalizer of claim 1, wherein the first register is clocked at a time that is offset from when the second register is clocked such that the first register and the second register sample alternating symbols of the modified input signal.

9. The decision feedback equalizer of claim 1, wherein:
the first path further includes a third register positioned between the summation circuit and the first register, the third register configured to output a third signal based on the modified input signal, the third register clocked such that the third signal has the sample symbol rate, wherein the first signal is a delayed version of the third signal, and
a second path further includes a fourth register positioned between the summation circuit and the second register, the fourth register configured to output a fourth signal based on the modified input signal, the fourth register clocked such that the fourth signal has the sample symbol rate, wherein the second signal is a delayed version of the fourth signal.

10. The decision feedback equalizer of claim 9, wherein the first path further includes a second summation circuit positioned between the third register and the summation circuit, the second summation circuit configured to receive the modified input signal and to subtract a modified fourth signal based on the fourth signal from the modified input signal, and
the second path further includes a third summation circuit positioned between the fourth register and the summation circuit, the third summation circuit configured to receive the modified input signal and to subtract a modified third signal based on the third signal from the modified input signal.

11. A decision feedback equalizer comprising:
an input node configured to receive an input signal with an input symbol rate;
a first sampler circuit configured to sample a modified input signal, which is based on the input signal and has the input symbol rate, at a sampling rate to generate a first signal, the sampling rate being less than the input symbol rate such that the first signal has a sample symbol rate less than the input symbol rate, the first sampler circuit further configured to delay the first signal to generate a delayed first signal;
a second sampler circuit configured to sample the modified input signal at the sampling rate to generate a second signal such that the second signal has the sample symbol rate, the second sampler circuit configured to sample the modified input signal at a time that is offset from when the first sampler circuit is configured to sample the modified input signal, the second sampler circuit further configured to delay the second signal to generate a delayed second signal; and
a summation circuit positioned between the input node and the first sampler circuit and positioned between the input node and the second sampler circuit, the summation circuit configured to:
receive a modified first signal based on the delayed first signal and a modified second signal based on the delayed second signal, the modified first signal and the modified second signal having the sample symbol rate,
subtract the modified first signal having the sampled symbol rate and the modified second signal having the sampled symbol rate from the input signal having the input symbol rate to generate the modified input signal, and
provide the modified input signal to the first sampler circuit and the second sampler circuit.

12. The decision feedback equalizer of claim 11, wherein the second sampler circuit is configured to sample the modified input signal at a time that is offset from when the first sampler circuit is configured to sample the modified input signal such that the first sampler circuit and the second sampler circuit sample alternating symbols of the modified input signal.

13. (canceled)

14. The decision feedback equalizer of claim 11, wherein:
the first sampler circuit is further configured to delay the delayed first signal to generate a second delayed first signal,
the second sampler circuit is further configured to delay the delayed second signal to generate a second delayed second signal, and
the summation circuit is configured to:
receive a second modified first signal based on the second delayed first signal and a second modified second signal based on the second delayed second signal, the second modified first signal and the second modified second signal having the sample symbol rate, and
subtract the second modified first signal and the second modified second signal from the input signal to generate the modified input signal.

15. The decision feedback equalizer of claim 11, further comprising a filter circuit positioned between the summation circuit and the first sampler circuit and the second sampler circuit, the filter circuit configured to apply coefficients to the delayed first signal and the delayed second signal to generate the modified first signal and the modified second signal and to provide the modified first signal and the modified second signal to the summation circuit.

16. The decision feedback equalizer of claim 15, wherein the filter circuit further comprises:
a first low-pass filter circuit configured to filter the delayed first signal; and
a second low-pass filter circuit configured to filter the delayed second signal,
wherein the first low-pass filter circuit filters the first signal and the second low-pass filter circuit filters the second signal before the filter circuit applies the coefficients to the first signal and the second signal.

17. A method of signal equalization, the method comprising:
sampling an input signal at a sampling rate to generate a first signal, the input signal having an input symbol rate that is greater than the sampling rate such that the first signal has a sample symbol rate that is less than the input symbol rate;
sampling the input signal at the sampling rate to generate a second signal such that the second signal has the sample symbol rate that is less than the input symbol rate, the sampling of the input signal to generate the first signal being offset in time from the sampling of the input signal to generate the second signal;
modifying the first signal to generate a modified first signal with the sample symbol rate;
modifying the second signal to generate a modified second signal with the sample symbol rate; and
subtracting the modified first signal and the modified second signal at the sample symbol rate from a pre-input signal at the input symbol rate to generate the input signal at the input symbol rate that is sampled to generate the first signal and the second signal.

18. The method of claim 17, wherein modifying the first signal includes applying a coefficient to the first signal and modifying the second signal includes applying the coefficient to the second signal.

19. The method of claim 18, further comprising, before applying the coefficient to the first signal and the second signal, low pass filtering the first signal and the second signal.

20. The method of claim 17, further comprising summing the first signal and the second signal before the first signal and the second signal are modified, such that the modified first signal and the modified second signal at the sample symbol rate are subtracted from the pre-input signal summed together.
